(19) United States
(12) Patent Application Publication
(10) Pub. No.: US 2014/0196922 A1
(43) Pub. Date: Jul. 17, 2014

(54) ELECTRIC POWER TOOL WITH IMPROVED VISIBILITY IN DARKNESS

(71) Applicant: Black & Decker Inc., Newark, DE (US)

(72) Inventors: Brian E. Friedman, Baltimore, MD (US); Paul J. Korick, York, PA (US)

(21) Appl. No.: 13/743,866

(22) Filed: Jan. 17, 2013

(51) Int. Cl. B23Q 17/24; B25F 5/02

(52) U.S. Cl. CPC B23Q 17/2404; B25F 5/02
USPC 173/46

(57) ABSTRACT

An electric power tool includes a motor and a motor housing at least partly encasing the motor. The motor housing has a top portion, a bottom portion opposite to the top portion, and side walls disposed between the top and bottom portions. A handle housing is connected to the bottom portion of the motor housing. A spindle is operatively connected to the motor. A first light assembly is disposed on a side wall of the motor housing.

### BACKGROUND

The present application generally relates to electric power tools and more particularly to an electric power tool that includes a light assembly.

### SUMMARY

An electric power tool is herein disclosed. The electric power tool comprises a motor, a motor housing at least partly encasing the motor, the motor housing having a top portion, a bottom portion opposite to the top portion, and first and second side walls disposed between the top and bottom portions, a handle housing connected to the bottom portion of the motor housing, a spindle operatively connected to the motor, the spindle being rotatable about a rotational axis, and a first light assembly disposed on one of the first and second side walls of the motor housing.

### BRIEF DESCRIPTION OF THE ATTACHED DRAWINGS

For a fuller understanding of the nature and objects of the present invention, reference should be made to the following detailed description and the accompanying drawings, in which:

FIG. 1 is an overall perspective view of an electric power tool. in accordance with the present invention.

FIGS. 2A and 2B are detailed views of the light assembly in accordance with the present invention, where FIGS. 2A and 2B are side and front views of the light assembly, respectively.

### DETAILED DESCRIPTION

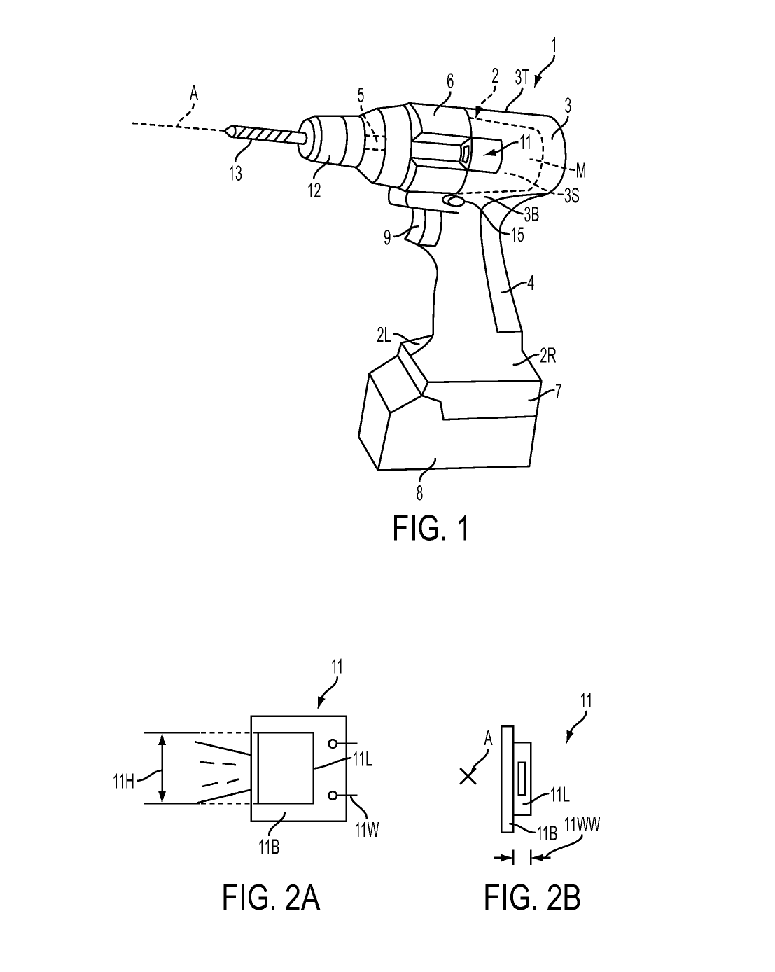

Referring to FIG. 1, an electric power tool 1 preferably includes a main housing 2 made of synthetic resin and preferably composed of left and right half casings (2L and 2R, respectively). These half casings 2L, 2R may be fitted together to form a motor housing 3 that encases a motor M in the rear portion thereof and a pistol grip handle 4 that preferably extends below from the motor housing 3 and encases a switch mechanism (not shown). Preferably, in each half casing 2L, 2R, the half motor housing 3 is integrally molded with the half grip pistol handle 4.

Coupled to the front portion of the motor housing 3 may be a metallic gear housing 6 that encases reduction gears and other components (not shown). Furthermore, a spindle 5 of the electric power tool 1 protrudes forward from the top portion of the metallic gear housing 6. An end effector, tool holder or chuck 12 may be rotationally fixed to spindle 5. Tool holder 12 preferably holds a tool 13, such as a drill bit, a hole saw, a screwdriving bit, a chisel, etc. Persons skilled in the art will recognize that spindle 5 (and thus tool holder or chuck 12, and tool 13) will rotate about a rotational axis A.

The electric power tool 1 may include at the bottom end of the grip handle 4 a battery pack coupling portion 7 to which is mounted a battery pack 8 containing a plurality of storage cells (not shown) that supplies electric power to the power tool 1. The battery-operated electric power tool 1 further includes an on/off trigger 9 that is impressed inward to operate the switch mechanism accommodated within the pistol grip handle 4.

A light assembly 11 is preferably disposed on the sides of power tool 1, preferably on the sides of housing 2, e.g., the left and right casings 2L, 2R. Persons skilled in the art will recognize that it is preferable to place light assemblies 11 near gear housing 6 and/or on motor housing 3.

Referring to FIGS. 1-2, the light assembly 11 preferably includes an encased light source 114 such as a light-emitting diode (LED), with the light emitting end of the light source 11L exposed at the front of the light assembly 11. As the light source 11L is electrically connected to the drive circuit of the motor, pulling in the on/off trigger 9 activates the motor and simultaneously switches on the light source 11L to illuminate any objects located in front of the tool bit 13.

Preferably, light source 11L is a side view LED, which is mounted on a board 11B. Wires 11W may be connected to board 11B for providing power to light source 11L.

A portion of (if not the entire) board 11B is preferably substantially parallel to rotational axis A. Persons skilled in the art shall recognize that side view LEDs, such as unit no. 50-215 manufactured by Everlight Electronics Co., Ltd. of Taiwan (ROCS), are typically installed on board 11B by moving it in an installation direction substantially perpendicular to a portion of (if not the entire) board 11B, and emit at least some (if not the majority) of light in a direction substantially perpendicular to the installation direction, Persons skilled. in the art shall also recognize that some (if not the majority) of the light emitted by light source 11L is preferably emitted in a direction substantially parallel to rotational axis A.

Referring to FIG. 2, the light source 11L preferably has a height 11H which is larger than the width 11WW thereof, This allows for a lower envelope profile compared to other LEDs, which can minimize the volume expansion of housing 2 necessary to accommodate light assemblies 11.

It should be noted that the present invention may be applicable not only to electric power tools, as in the foregoing embodiment but also to power drills, driver-drills, impact torque wrenches, and other electric power tools, whether they are battery operated tools or AC (alternating current) tools.

It will thus be seen that the present invention efficiently attains the objects set forth above, among those made apparent from the preceding description. As other elements may be modified, altered, and changed without departing from the scope or spirit of the essential characteristics of the present invention, it is to be understood that the above embodiments are only an illustration and not restrictive in any sense. The scope or spirit of the present invention is limited only by the terms of the appended claims.

What is claimed is:

1. An electric power tool comprising:
a motor;
a motor housing at least partly encasing the motor, the motor housing having a top portion, a bottom portion opposite to the top portion, and first and second side walls disposed between the top and bottom portions;
a handle housing connected to the bottom portion of the motor housing;
a spindle operatively connected to the motor, the spindle being rotatable about a rotational axis;
an end effector operatively connected to the spindle; and
a first light assembly disposed on at least one of the first and second side walls of the motor housing and configured to illuminate a region adjacent the end effector.

2. The electric power tool of claim 1, wherein the first light assembly comprises a board having at least one portion thereof being substantially parallel to the rotational axis, and a side view LED mounted on the board.

3. The electric power tool of claim 2, wherein the side view LED has a height and width, the height being larger than the width.

4. The electric power tool of claim 2, wherein the side view LED is installed on the board by moving it in a direction substantially perpendicular to the at least one portion of the board.

5. The electric power tool of claim 2, wherein the side view LED emits some light substantially parallel to the rotational axis.

6. The electric power tool of claim 2, wherein the side view LED emits some light substantially perpendicular to the at least one portion of the board.

7. The electric power tool of claim 1, further comprising a second light assembly disposed on the other of the first and second side walls of the motor housing.

8. An electric power tool comprising:
a motor;
a motor housing at least partly encasing the motor, the motor housing having a top portion, a bottom portion opposite to the top portion, and first and second side walls disposed between the top and bottom portions;
a handle housing connected to the bottom portion of the motor housing;
a spindle operatively connected to the motor, the spindle being rotatable about a rotational axis; and
a first light assembly disposed on the motor housing, the first light assembly comprising a board having at least one portion thereof being substantially parallel to the rotational axis, and a side view LED mounted on the board.

9. The electric power tool of claim 8, wherein the side view LED has a height and width, the height being larger than the width.

10. The electric power tool of claim 8, wherein the side view LED is installed on the board by moving it in a direction substantially perpendicular to the at least one portion of the board.

11. The electric power tool of claim 8, wherein the side view LED emits some light substantially parallel to the rotational axis.

12. The electric power tool of claim 8, wherein the side view LED emits some light substantially perpendicular to the at least one portion of the board.

13. The electric power tool of claim 8, further comprising a second light assembly disposed on the motor housing.
